(19) United States
(12) Patent Application Publication
(10) Pub. No.: US 2014/0129804 A1
(43) Pub. Date: May 8, 2014

(54) TRACKING AND RECLAIMING PHYSICAL REGISTERS

(71) Applicant: John M. King, Austin, TX (US)

(72) Inventor: John M. King, Austin, TX (US)

(21) Appl. No.: 13/667,354

(22) Filed: Nov. 2, 2012

(51) Int. Cl. G06F 15/76

(52) U.S. Cl. 712/30; 712/E09.003

(57) ABSTRACT

A method and apparatus for tracking and reclaiming physical registers is presented. Some embodiments of the apparatus include rename logic configurable to map architectural registers to physical registers. The rename logic is configurable to bypass allocation of a physical register to an architectural register when information to be written to the architectural register satisfies a bypass condition. Some embodiments of the apparatus also include a plurality of first bits associated with the architectural registers. The rename logic is configurable to set one of the first bits to indicate that allocation of a physical register to the corresponding architectural register has been bypassed.

### CROSS REFERENCE TO RELATED APPLICATIONS

This application is related to U.S. patent application Ser. No. 12/828,402, filed on Jul. 1, 2010, which is incorporated herein by reference in its entirety. This application is also related to U.S. patent application Ser. No. 12/900,124, filed Oct. 7, 2010, which is incorporated herein by reference in its entirety.

### BACKGROUND

This application relates generally to processor-based systems, and, more particularly, to physical registers in processor-based systems.

Conventional processor-based systems typically include one or more processing elements such as a central processing unit (CPU), a graphical processing unit (GPU), an accelerated processing unit (APU), and the like. The processing units include one or more processor cores that are configured to access instructions or data that are stored in a main memory and then execute the instructions or manipulate the data. Processor cores include a floating point unit (FPU) that is used to perform mathematical operations on floating point (FP) numbers when required by the executed instructions. For example, conventional floating-point units are typically designed to carry out operations such as addition, subtraction, multiplication, division, and square root. Some systems can also perform various transcendental functions such as exponential or trigonometric calculations. Floating-point operations may be handled separately from integer operations on integer numbers. The floating-point unit may also have a set of dedicated floating-point registers for storing floating-point numbers.

The floating-point units implemented in processor-based systems typically include a set of physical registers in a physical register file. The physical registers may be used to store different types of information during operation of the floating-point unit. For example, physical registers may be used to store data for in-flight operations until this data is committed to the state of the machine. For another example, instruction set architectures (ISA) may support a set of named architectural (or micro-architectural) registers that can be used in software created for the machine. The architectural registers can be mapped to the physical registers in the physical register file, e.g., using renaming logic that maps the name of the architectural register to a physical register number that identifies a physical register. In operation, the physical registers can be allocated to in-flight operations or architectural registers as needed, depending on the availability of the physical registers in the physical register file.

Floating-point units can support multiple floating-point instruction sets. For example, the x86 architecture instruction set includes a floating-point related subset of instructions that is referred to as x87. The x87 instruction set includes instructions for basic floating point operations such as addition, subtraction and comparison, as well as for more complex numerical operations such as the tangent and arc-tangent functions. Floating-point instructions in the x87 instruction set can use a set of architected registers that can be mapped to physical registers in the floating-point unit. For another example, computers that include multiple processing cores may support a single instruction, multiple data (SIMD) instruction set. The x86 architecture SIMD instruction set supports a subset of instructions that are referred to as Multi-Media Extensions (MMX). Floating-point instructions in the MMX instruction set use the same set of architected registers as the x87 instruction set. These registers are thus conventionally known as x87/MMX registers. The x86 architecture SIMD instruction set supports another floating-point related subset of instructions that are referred to as Streaming SIMD Extensions (SSE). Floating-point instructions in the SSE instruction set can use another set of architected registers (conventionally known as XMM registers) that can also be mapped to physical registers in the floating-point unit. The Advanced Vector Extension (AVX) instruction set is an advanced version of SSE that defines 256-bit versions of the SSE instructions, as well as new instructions, and extends the XMM registers to be 256 bits wide.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, an apparatus is provided for tracking and reclaiming physical registers. Some embodiments of the apparatus include rename logic configurable to map architectural registers to physical registers. The rename logic is configurable to bypass allocation of a physical register to an architectural register when information associated with the architectural register satisfies a bypass condition. Some embodiments of the apparatus also include a plurality of first bits associated with the architectural registers. The rename logic is configurable to set one of the first bits to indicate that allocation of a physical register to the corresponding architectural register has been bypassed. Embodiments of a computer readable media including instructions that when executed can configure a manufacturing process used to manufacture a semiconductor device including the apparatus are also provided.

In some embodiments, a method is provided for tracking and reclaiming physical registers. Some embodiments of the method include bypassing allocation of a physical register to an architectural register when information associated with the architectural register satisfies a bypass condition. Some embodiments of the method also include setting one or more first bits to indicate that allocation of a physical register to the architectural register has been bypassed.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a computer system, according to some embodiments;

FIG. 2 conceptually illustrates architectural registers used by different instruction set architectures, according to some embodiments;

FIG. 3 conceptually illustrates a portion of a floating-point unit, according to some embodiments;

FIG. 4 conceptually illustrates a first example of rename logic, according to some embodiments;

FIG. 5 conceptually illustrates a method for determining whether to allocate or bypass allocation of physical registers to architectural registers, according to some embodiments;

FIG. 6 conceptually illustrates a second example of rename logic, according to some embodiments;

FIG. 7 conceptually illustrates a portion of a floating-point unit, such as the floating-point units shown in FIGS. 1 and 3, according to some embodiments; and

FIG. 8 conceptually illustrates a method for dynamically detecting all-zero registers, according to some embodiments.

While the disclosed subject matter may be modified and may take alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The description and drawings merely illustrate the principles of the claimed subject matter. It should thus be appreciated that those skilled in the art may be able to devise various arrangements that, although not explicitly described or shown herein, embody the principles described herein and may be included within the scope of the claimed subject matter. Furthermore, all examples recited herein are principally intended to be for pedagogical purposes to aid the reader in understanding the principles of the claimed subject matter and the concepts contributed by the inventor(s) to furthering the art, and are to be construed as being without limitation to such specifically recited examples and conditions.

The disclosed subject matter is described with reference to the attached figures. Various structures, systems and devices are schematically depicted in the drawings for purposes of explanation only and so as to not obscure the disclosed embodiments with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. Additionally, the term, “or,” as used herein, refers to a non-exclusive “or,” unless otherwise indicated (e.g., “or else” or “or in the alternative”). Also, the various embodiments described herein are not necessarily mutually exclusive, as some embodiments can be combined with one or more other embodiments to form new embodiments.

As discussed herein, floating-point units are expected to support numerous ISA register formats at least in part to maintain backwards compatibility. For example, x87/MMX registers are architecturally 80-bits wide, SSE registers are architecturally 128-bits wide, and AVX registers extend the SSE register format up to 256-bits wide. The different sizes of the different architectural register formats may be accommodated using physical registers that are 128 bits wide. The architectural registers for x87/MMX therefore use a subset of the available bits in a physical register and the AVX architectural registers may be mapped to two physical registers to accommodate the 256 bit width. However, the AVX format supports both 128-bit instructions and 256-bit instructions. The AVX 128-bit instructions zero out the upper 128 bits of the 256-bit architectural register.

Mapping architected registers for the different instruction sets to physical registers in the floating-point unit consumes area on the chip, timing resources, and power. Depending on the instruction sets used by different applications, the resources that are allocated to the different types of instruction sets may not be used, thereby reducing the efficiency of the processing unit. For example, reserving a physical register for storing the zeroed out portion of the 256-bit architectural register prevents the physical register from being used for other instructions such as in-flight instructions. Reserving a physical register for other all-zero data entries or unused architectural registers may similarly reduce the available number of physical registers for in-flight operations. Embodiments of the techniques described herein may be used to reduce or eliminate one or more of the aforementioned problems in the conventional practice.

As discussed herein, reserving a physical register for architectural registers that store information (or are going to store information in the future) satisfying a bypass condition prevents the physical register from being used by other instructions such as in-flight instructions. The information (e.g., data) satisfies a bypass condition when the information includes a bit pattern that is all-zeros, when the information includes a predetermined bit pattern (e.g., the upper 128 bits of a 256 bit register are all zeros, the register includes a non-zero configurable bit pattern that can be identified, etc.), or when the information includes unusable or “dead” data. Embodiments of the techniques described herein may address one or more of these deficiencies in the conventional practice by incorporating logic that can determine whether an architectural register stores information satisfying a bypass condition (e.g., all zeros). The architectural register may be mapped to a physical register number that is not associated with a physical register when the architectural register stores information satisfying a bypass condition. The mapping of the architectural register to the physical register number includes an indication that the architectural register stores information satisfying a bypass condition. Bypass logic may then provide a configurable bit pattern to instructions that access the architectural register that has not been allocated a physical register.

In some embodiments, the indication includes a bit that is associated with the architectural register. The bit may be one of an array of bits implemented in the renaming or mapping logic used to map architectural registers to physical register numbers. The bit can be set to indicate that the architectural register may be used to store information satisfying a bypass condition. One exemplary bypass condition occurs when an architectural register either stores or is going to store all zeros. For example, a bypass condition may occur when the upper 128 bits of an AVX 256-bit architectural register are zeroed out because the 256-bit architectural register is used by a 128-bit instruction. For another example, a bypass condition may occur when memory data that is to be written or loaded into an architectural register is all zeros. Some embodiments may also be able to detect a bypass condition when the memory data loaded into an architectural register is some other configurable bit pattern besides all zeros. If the bit is set, the system bypasses allocating a physical register to the architectural register because it is understood that the architectural register stores information satisfying a bypass condition. Thus, instead of allocating a physical register to store the information satisfying the bypass condition, the physical register is free to be allocated to other architectural registers or in-flight operations. In some embodiments, the bit may also be set in response to an instruction that generates the information satisfying the bypass condition (e.g., an instruction that zeros out an architectural register). The corresponding physical register may be freed in response to the zeroing instruction so that it is available for allocation to other architectural registers or in-flight operations. For example, the previous physical register may be freed when the zeroing instruction retires and no new physical register is mapped.

Some embodiments may use the bits associated with the architectural registers, as well as other information associated with the architectural registers or the physical registers, to free or reclaim physical registers that are associated with architectural registers that store information satisfying a bypass condition (e.g., architectural registers that store all-zeros, that store a predetermined bit pattern, or that are known to hold unusable data). Unusable data is data that for any reason should not be used by instructions because it may cause the instruction to return an incorrect result or perform an incorrect action. Unusable data may also be referred to as “dead” data. Techniques for detecting or identifying unusable data are known in the art. The term “bypass” is therefore understood herein to encompass actions including deciding not to allocate a physical register that would ordinarily have been allocated to an architectural register or freeing a physical register that was previously allocated to an architectural register even though the architectural register may still be referenced by one or more instructions.

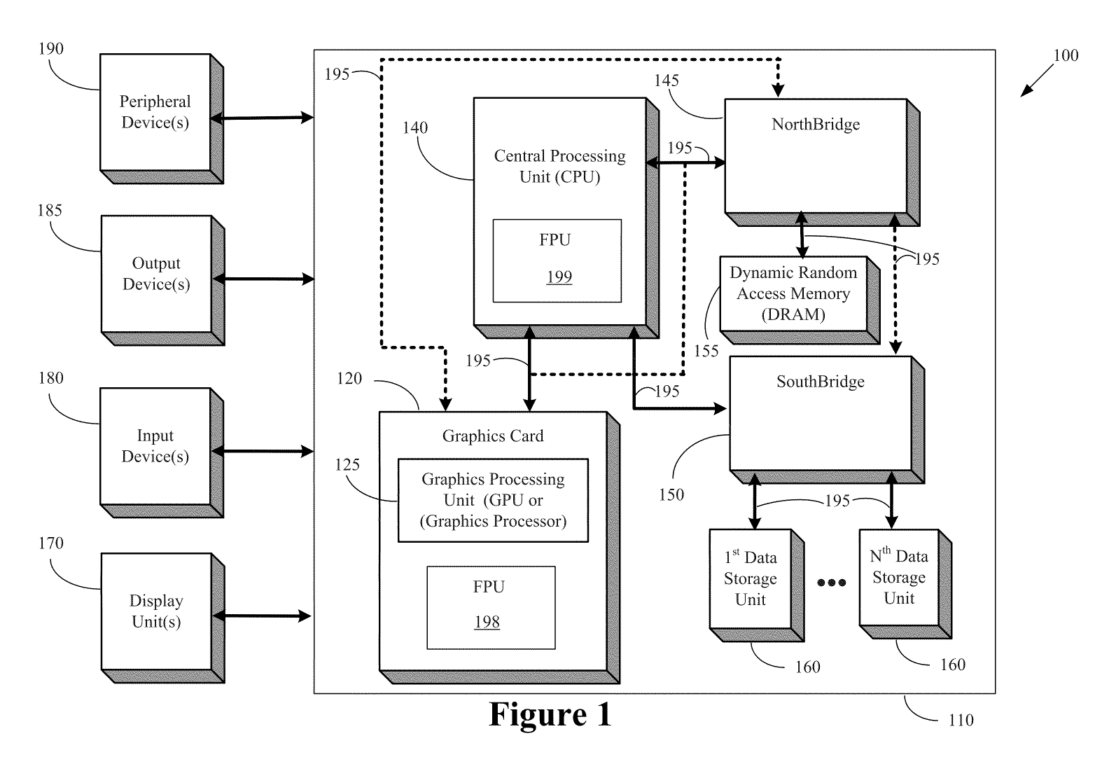

FIG. 1 conceptually illustrates a computer system 100, according to some embodiments. The computer system 100 may be a personal computer, a laptop computer, a handheld computer, a netbook computer, a mobile device, a tablet computer, a netbook, an ultrabook, a telephone, a personal data assistant (PDA), a server, a mainframe, a work terminal, a smart television, or the like. The computer system includes a main structure 110 which may be a computer motherboard, system-on-a-chip, circuit board or printed circuit board, a desktop computer enclosure or tower, a laptop computer base, a server enclosure, part of a mobile device, tablet, personal data assistant (PDA), or the like. The computer system 100 may run an operating system such as Linux, Unix, Windows, Mac OS, or the like.

In some embodiments, the main structure 110 includes a graphics card 120. For example, the graphics card 120 may be an ATI Radeon™ graphics card from Advanced Micro Devices (“AMD”). The graphics card 120 may, in different embodiments, be connected on a Peripheral Component Interconnect (PCI) Bus (not shown), PCI-Express Bus (not shown), an Accelerated Graphics Port (AGP) Bus (also not shown), or other electronic or communicative connection. The graphics card 120 may include a graphics processing unit (GPU) 125 used in processing graphics data. The graphics card 120 may be referred to as a circuit board or a printed circuit board or a daughter card or the like.

The computer system 100 shown in FIG. 1 also includes a central processing unit (CPU) 140, which is electronically or communicatively coupled to a northbridge 145. The CPU 140 and northbridge 145 may be housed on the motherboard (not shown) or some other structure of the computer system 100. It is contemplated that in certain embodiments, the graphics card 120 may be coupled to the CPU 140 via the northbridge 145 or some other electronic or communicative connection. For example, CPU 140, northbridge 145, GPU 125 may be included in a single package or as part of a single die or “chip”. The northbridge 145 may be coupled to a system RAM (or DRAM) 155 or the system RAM 155 may be coupled directly to the CPU 140. The system RAM 155 may be of any RAM type known in the art; the type of system RAM 155 may be a matter of design choice. The northbridge 145 may be connected to a southbridge 150. The northbridge 145 and southbridge 150 may be on the same chip in the computer system 100, or the northbridge 145 and southbridge 150 may be on different chips. The southbridge 150 may be connected to one or more data storage units 160. The data storage units 160 may be hard drives, solid state drives, magnetic tape, or any other writable media used for storing data. In various embodiments, the CPU 140, northbridge 145, southbridge 150, GPU 125, or system RAM 155 may be a computer chip or a silicon-based computer chip, or may be part of a computer chip or a silicon-based computer chip. In The various components of the computer system 100 may be operatively, electrically or physically connected or linked with a bus 195 or more than one bus 195.

The computer system 100 may be connected to one or more display units 170, input devices 180, output devices 185, or peripheral devices 190. These elements may be internal or external to the computer system 100, and may be wired or wirelessly connected. The display units 170 may be internal or external monitors, television screens, handheld device displays, touchscreens, and the like. The input devices 180 may be any one of a keyboard, mouse, track-ball, stylus, mouse pad, mouse button, joystick, touchscreen, scanner or the like. The output devices 185 may be any one of a monitor, printer, plotter, copier, or other output device. The peripheral devices 190 may be any other device that can be coupled to a computer. Example peripheral devices 190 may include a CD/DVD drive capable of reading or writing to physical digital media, a USB device, Zip Drive, external hard drive, phone or broadband modem, router/gateway, access point or the like.

The GPU 125 and the CPU 140 may implement floating point units (FPUs) 198, 199, respectively. The FPUs 198, 199 are configurable to carry out operations on floating point numbers such as addition, subtraction, multiplication, division, and square root. The instruction set architecture (ISA) used by the FPUs 198, 199 may specify a set of architectural registers that can be used by instructions, e.g., instructions in programs written for execution by the computer system 100. Instructions executed by the FPUs 198, 199 may read or write the architectural registers. The FPUs 198, 199 also implement a physical register file that includes physical registers used to store the information associated with the architectural registers. The FPUs 198, 199 may therefore include mapping tables that can be used to map the architectural registers to numbers indicating the actual physical registers. As discussed herein, the mapping tables may be configurable to map architectural registers that have different sizes (e.g., the architectural registers defined by different instruction set architectures) to a common set of physical registers in a physical register file.

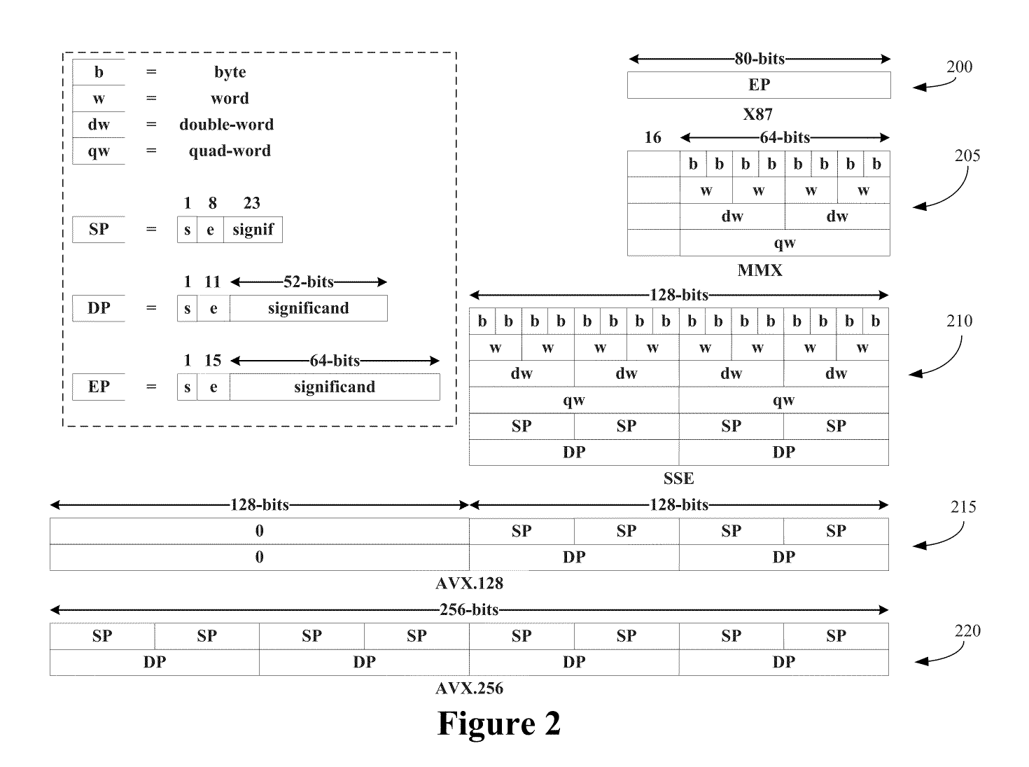

FIG. 2 conceptually illustrates architectural registers used by different instruction set architectures, according to some embodiments. An 80-bit architectural register 200 is used by the x87 instruction set. An alternative 80-bit architectural register 205 may be used by the MMX instruction set. The SSE instruction set extends the length of architectural registers to a 128-bit architectural register 210. The architectural registers 200, 205, 210 may be mapped to 128-bit physical registers. The AVX instruction set uses 256-bit architectural registers 215, 220 but the architectural register 215 defines 128 bits as 0 to support 128 bit instructions. The architectural registers 215, 220 may be mapped to two 128-bit physical registers. Alternatively, as discussed herein, a first 128-bit portion of the architectural register 215 may be mapped to a physical register and allocation of a physical register to a second all-zero 128-bit portion of the architectural register 215 may be bypassed.

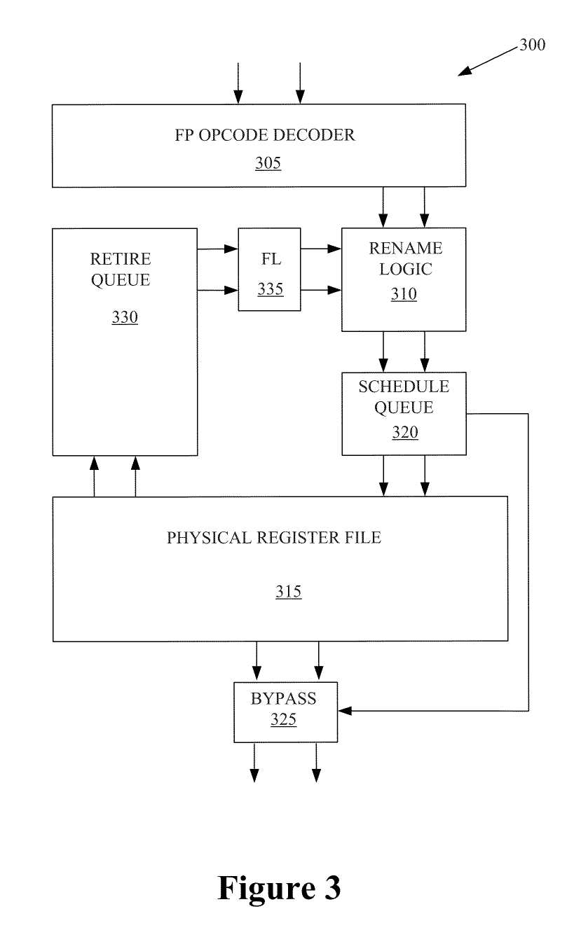

FIG. 3 conceptually illustrates a portion of a floating-point unit 300 such as the FPUs 198, 199 shown in FIG. 1, according to some embodiments. In some embodiments, the floating-point unit 300 includes an instruction decoder 305 that is configured to decode incoming floating-point instructions. As used herein, the term “instruction” may also encompass operations (or ops), micro-operations, opcodes, and the like. Instructions may be fetched from memory, e.g. RAM or DRAM such as the DRAM 155 depicted in FIG. 1. The instruction decoder 305 may also be configured to identify the instruction set architecture used by the incoming instruction. For example, the instruction decoder 305 may be able to determine whether the incoming instruction is a part of the x87, MMX, SSE, or AVX instruction set architectures and may then decode the incoming instruction according to the appropriate architecture. The instruction decoder 305 may also be able to determine whether the destination register associated with the instruction will be written with a configurable bit pattern. For example, the instruction decoder 305 may be able to detect, at dispatch time, destinations that are 128-bit AVX architectural registers and therefore include 128 bits that are set to zero

The floating-point unit 300 also includes rename logic 310 that maps architectural registers to one or more physical registers in a physical register file 315. in some embodiments, the rename logic 310 includes an array of bits (which may be referred to as Zbits) that are each associated with one of the architectural registers. The rename logic 310 may set the Zbit corresponding to an architectural register when the rename logic 310 (or other functionality within the floating-point unit 300) determines that the contents of the architectural register correspond to a configurable bit pattern, such as all zeros or unused data.

A schedule queue 320 may be used to schedule execution of instructions in the floating-point unit 300. In some embodiments, the rename logic 310 provides information (such as a physical register number) indicating the identity of the physical register(s) allocated to architectural register(s) that are referenced by the instructions. The schedule queue 320 may therefore schedule reads or writes to the physical registers in the physical register file 315 and the results may be passed to other portions of the floating-point unit 300, e.g. for performing multiply or add operations on the source operands that were read from the physical register file 315. However, if the rename logic 310 determines that the Zbit associated with the architectural register has been set, indicating that allocation of a physical register has been bypassed and no physical register is associated with the architectural register, the schedule queue 320 can bypass reading or writing the physical register file 315.

In some embodiments, the floating-point unit 300 includes bypass logic 325 that can receive signals from the schedule queue 320 indicating that the schedule queue 320 has bypassed accessing the physical register file 315 because no physical register is associated with an architectural register referenced by the instruction. The bypass logic 325 may then generate the configurable bit pattern associated with the architectural register and provide the configurable bit pattern to other portions of the floating-point unit 300, e.g., as the source operands for the instruction. For example, the bypass logic 325 may provide zeros to fill the 128 zero bits of a 128-bit AVX architectural register when the 128-bit AVX architectural register is a source operand for an instruction. The control signal provided by the scheduler queue 320 may therefore indicate whether the bypass logic 325 generates and provides zeros as outputs or passes through the information provided by the physical register file 315. Some embodiments of the bypass logic 325 may be implemented in software, firmware, hardware, or a combination thereof.

The floating-point unit 300 also includes a retire queue 330 that stores instructions that are waiting to retire or are in the process of being retired. A free list (FL) 335 includes entries associated with the physical registers in the physical register file. In some embodiments, the physical register file 315 includes 72 physical registers and, therefore, the free list 335 may include up to 72 entries corresponding to these physical registers. Entries in the free list 335 indicate whether the corresponding physical register is “free” so that the physical register can be allocated to a decoded instruction or other in-flight operation. The retire queue 330 can signal the free list 335 when an instruction has retired so that the physical registers currently mapped as the destination architectural register referenced by the retired instruction can be freed for allocation to other instructions or operations, since the retired instruction maps a new physical register to that architectural register. The free list 335 may also communicate with the rename logic 310 so that the rename logic 310 knows when a physical register has been freed for allocation to an architectural register.

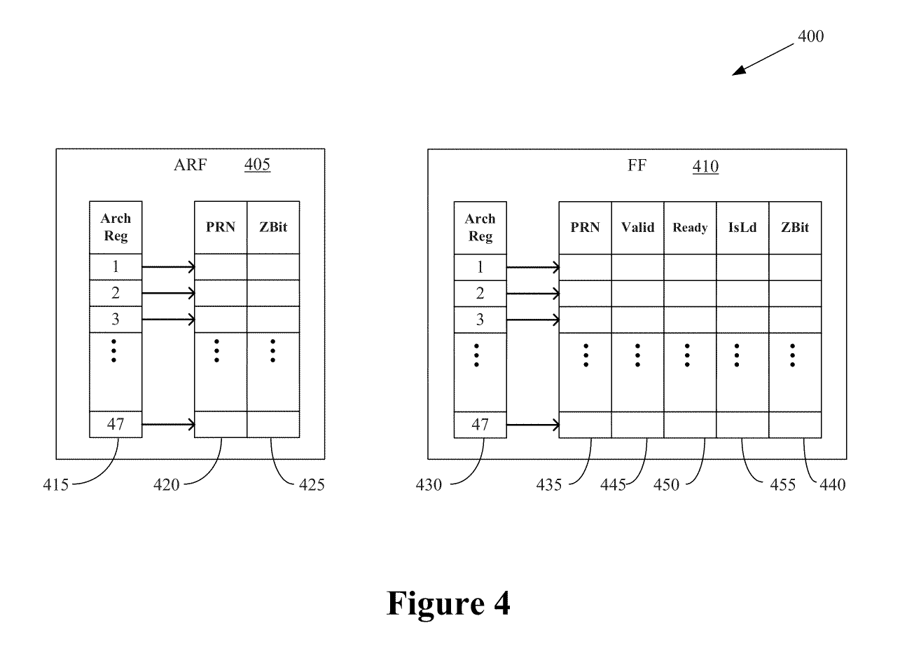

FIG. 4 conceptually illustrates rename logic 400, according to some embodiments. In some embodiments, the rename logic 400 includes an architectural register file (ARF) 405 that maps architectural registers (0-47) to physical registers and a future file (FF) 410 that maps speculative values of architectural registers (0-47) to physical registers. The ARF 405 comprises a retire-time, non-speculative map table and the FF 410 comprises a dispatch-time (speculative) map table.

In some embodiments, the ARF 405 includes an array 415 that includes information indicating the available architectural registers and an array 420 that includes information indicating the physical register number (PRN) of the physical register that is mapped to the corresponding architectural register. The ARF 405 also includes an array 425 that includes the Zbits associated with the corresponding architectural registers. When a physical register has been allocated to an architectural register, the physical register number identifying the allocated physical register is stored in the corresponding entry in the array 420 and the value of the Zbit in the corresponding entry in the array 425 is set to 0. The Zbit in the corresponding entry in the array 425 may alternatively be set to 1 to indicate that allocation of a physical register to the architectural register has been bypassed so that no actual physical register has been allocated to the architectural register. In this case, the value of the corresponding entry in the array 420 is not used to identify an actual physical register and consequently the entry may take on any value.

The FF 410 also includes an array 430 that includes information indicating the available architectural registers, an array 435 that includes information indicating the physical register number (PRN) of the physical register mapped to the architectural register, and an array 440 that includes Zbits associated with the corresponding architectural registers. In some embodiments, the FF 410 also includes an array 445 of valid bits, an array 450 of ready bits, and an array 455 of IsLd bits. The arrays 445, 450, 455 may be used to track whether the physical register that is mapped to the corresponding architectural register is “ready” (e.g., whether the operation that produces its data has completed or not) at dispatch. When a physical register has been allocated to an architectural register in response to decoding a speculative instruction, the physical register number identifying the allocated physical register is stored in the corresponding entry in the array 430 and the value of the Zbit in the corresponding entry in the array 445 is set to 0. The Zbit in the corresponding entry in the array 440 may alternatively be set to 1 to indicate that allocation of a physical register to the architectural register has been bypassed so that no actual physical register has been allocated to the architectural register. In this case, the value of the corresponding entry in the array 435 is not used to identify an actual physical register and may therefore take on any value.

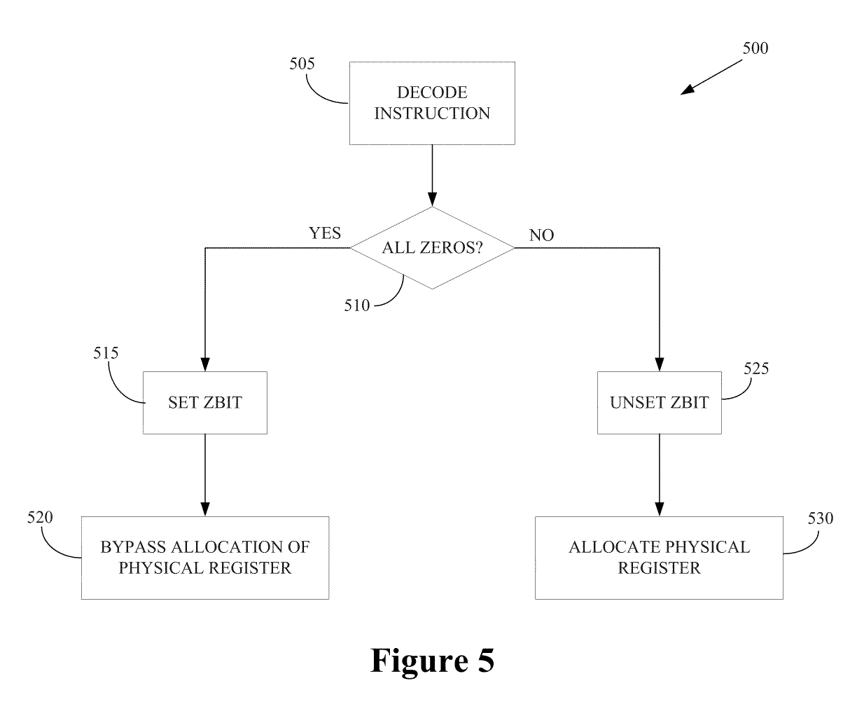

FIG. 5 conceptually illustrates a method 500 for determining whether to allocate or bypass allocation of physical registers to architectural registers, according to some embodiments. In some embodiments, architectural registers that have all zeros are not allocated physical registers. Some embodiments use other configurable bit patterns to determine whether to bypass allocation of physical registers to architectural registers that include reconfigurable patterns. Some embodiments bypass allocation of physical registers when the architectural register includes unusable or unused data such as architectural registers that are reserved for x87 instructions even though the floating point unit is not executing a program that includes x87 instructions. Techniques for bypassing allocation of physical registers to architectural registers that include all zeros, other configurable bit patterns, unusable, or unused data may be combined in some embodiments.

A decoder such as the FP opcode decoder 305 shown in FIG. 3 decodes (at 505) an instruction. The floating-point unit then determines (at 510) whether portions of architectural registers associated with the decoded instructions include all zeros. For example, the FP opcode decoder 305 may determine (at 510) that the destination architectural register of the instruction is expected to write a portion defined to be all zeros such as 128 bits of a 256-bit AVX architectural register. For another example, the FP opcode decoder 305 may determine (at 510) that the instruction “zeros out” a portion of an architectural register by causing all the bits in the portion to be set to zero.

The rename logic 310 sets (at 515) a Zbit associated with the architectural register that includes all zeros and bypasses (at 520) allocation of a physical register to the architectural register. For example, the rename logic 310 may bypass (at 520) allocation of a physical register to an architectural register by not allocating a physical register to the 128 zero bits of a 256-bit architectural register. For another example, the rename logic 310 may bypass (at 520) allocation of a physical register to an architectural register by freeing the physical register in response to determining (at 510) that the decoded instruction zeros out the contents of the physical register. The mapping of the zeroed-out architectural register to the physical register may however be maintained in a mapping table such as the ARF 405 or the FRF 410 shown in FIG. 4. When the decoded instruction writes to an architectural register and its destination value is not detected to be all zeros, the rename logic 310 unsets (at 525) the corresponding Zbit and allocates (at 530) a physical register to the architectural register.

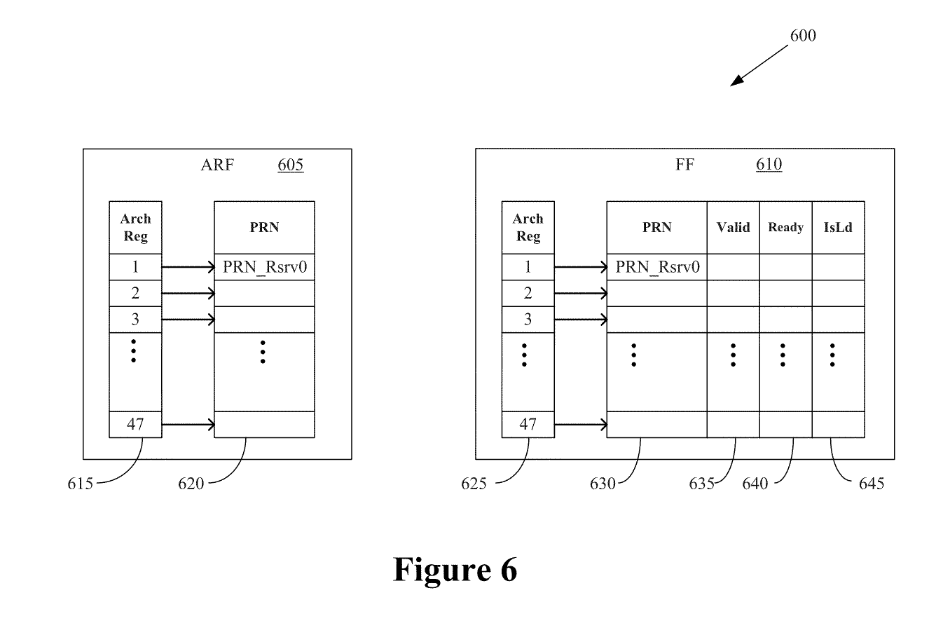

FIG. 6 conceptually illustrates rename logic 600, according to some embodiments. In some embodiments, the rename logic 600 includes an architectural register file (ARF) 605 that maps architectural registers (0-47) to physical registers and a future file (FF) 610 that maps speculative values of architectural registers (0-47) to physical registers.

In some embodiments, the ARF 605 includes an array 615 that includes information indicating the available architectural registers and an array 620 that includes information indicating the physical register number (PRN) of the physical register that is mapped to the corresponding architectural register. The rename logic 600 differs from the rename logic 400 shown in FIG. 4 by using a reserved value of a physical register number (PRN_Rsrv0) to indicate that allocation of the architectural register has been bypassed. The reserved value is a matter of design choice. When a physical register has been allocated to an architectural register, the physical register number identifying the allocated physical register is stored in the corresponding entry in the array 620. The physical register number in the corresponding entry in the array 620 may alternatively be set to PRN_Rsrv0 to indicate that allocation of a physical register to the architectural register has been bypassed so that no actual physical register has been allocated to the architectural register.

The FF 610 also includes an array 625 that includes information indicating the available architectural registers, an array 630 that includes information indicating the physical register number (PRN) of the physical register mapped to the architectural register, an array 635 of valid bits, an array 640 of ready bits, and an array 645 of IsLd bits. When a physical register has been allocated to an architectural register in response to decoding a speculative instruction, the physical register number identifying the allocated physical register is stored in the corresponding entry in the array 630. The physical register number in the corresponding entry in the array 620 may alternatively be set to PRN_Rsrv0 to indicate that allocation of a physical register to the architectural register has been bypassed so that no actual physical register has been allocated to the architectural register.

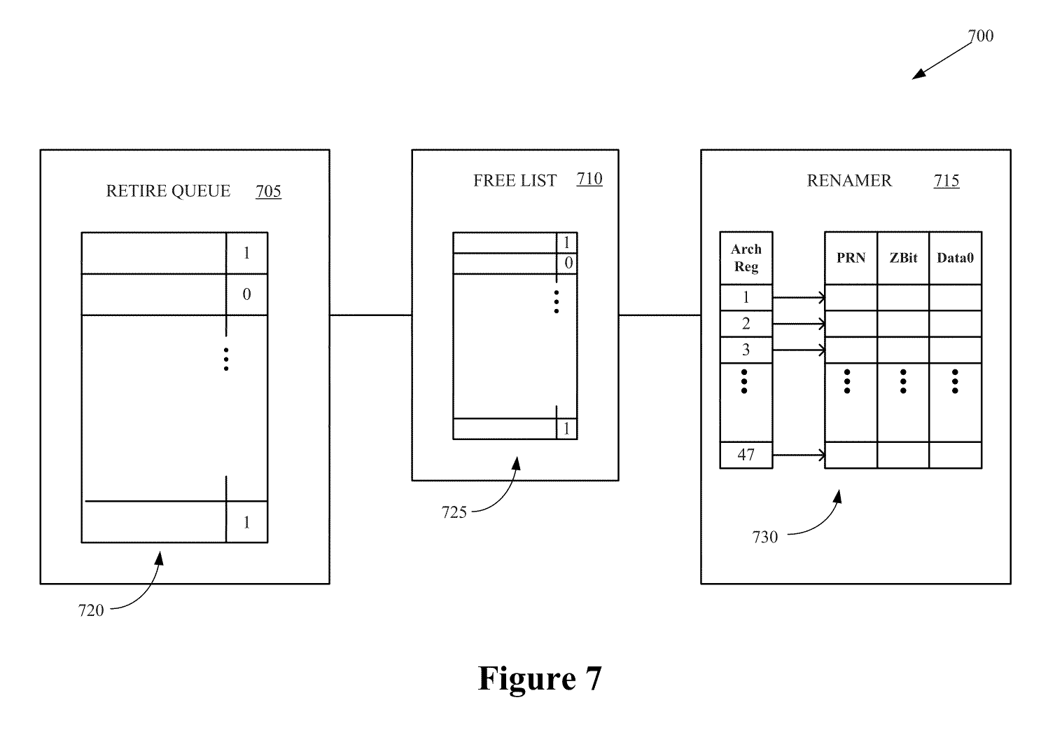

FIG. 7 conceptually illustrates a portion 700 of a floating-point unit, such as the FPUs 198, 199, 300 shown in FIGS. 1 and 3, according to some embodiments. The floating-point unit 700 shown in FIG. 7 includes a retire queue 705, a free list 710, and a renamer 715. The retire queue 705 includes a data structure 720 that stores instructions that are waiting to retire or are in the process of being retired. The data structure 720 also includes an array of bits associated with the architectural registers referenced by instructions in the retire queue 330. The bits may be set (e.g., to 1) to indicate that the corresponding architectural registers include a configurable bit pattern such as all zeros. For example, the bit associated with an architectural register may be set upon retirement of a zeroing operation that zeros out all of the bits of a 128-bit register. The free list 710 includes a data structure 725 having entries associated with the physical registers in the physical register file used by the floating point unit 700. In some embodiments, the physical register file includes 72 physical registers and so the free list 710 may include up to 72 entries corresponding to these physical registers. The entries in the data structure 725 for the free list 710 indicate whether the corresponding physical register is “free” (e.g., the bit is set to 1) so that they can be allocated to a decoded instruction or other in-flight operation. The renamer 715 includes a data structure 730 such as a mapping table that maps the architectural registers to physical register numbers, as discussed herein. The data structure 730 includes information indicating Zbits associated with the architectural registers and information indicating which registers in the retire queue 705 include all-zero data. In some embodiments, this information is a vector of bits that may be referred to as a Data0 vector, which is structured just like the rename table's ZBit array—48 entries, one per architectural register.

Embodiments of the data structure 720, 725, 730 may be used to bypass allocation of physical registers to architectural registers based on data values that are produced by execution units or data loaded from memory. For example, some embodiments may be used to retain or recover Zbit values following operations such as full floating-point register loading instructions like FXRSTOR/XRSTOR, as well as CC6 restore. Some embodiments may perform dynamic detection of configurable sequences of bits in registers using an instruction such as a op—referred to herein as FPKLDTEST—that can perform zero detection on data loaded from memory. The FXRSTOR, XRSTOR, and CC6-restore microcode routines may be configured to use FPKLDTEST to perform floating-point state restores of XMM and YMM registers.

Some embodiments of the FPKLDTEST operation are configured as a load-execute op that sets a zero-detect status bit in the data structure 720 of the retire queue 705 (e.g., the status bit is set to a value of 1) if the memory data in the corresponding architectural register is all zeros. At retire, the retire queue 705 reads out the zero-detect status bit and uses that to set ZBits for the architectural registers in the data structure 730 maintained by the renamer 715. In some embodiments, the retire queue 705 is not configured to set bits in the renamer's retire-time ZBit array directly because the ZBit array in the data structure 730 may be used for floating-point physical register file token accounting. To support the token accounting, the Zbit array in the data structure 730 should be kept consistent with a speculative, decode-time ZBit array. The speculative Zbit array is not aware of dispatching and decoding of the FPKLDTEST op for the data-based zero detection and consequently allowing the retire queue 705 to directly change the Zbit array in the renamer 715 could lead to an inconsistency between the speculative and non-speculative Zbit arrays. The retire queue 705 may therefore use the zero-detect status bit in the data structure 720 to set bits in the Data0 array to track which registers have zero data.

The free list 710 tracks the physical registers that are mapped to the Data0 registers using a 72-entry bit-vector in the data structure 725. This vector may be referred to as the ArchZeroDataVector. In response to the floating-point unit receiving an abort command that terminates a program or series of instructions, the Data0 array may be used to update the speculative and non-speculative Zbit arrays in the renamer 715. For example, the Data0 array may be OR'd into both the speculative and non-speculative ZBit arrays to set the ZBits for any full-zero registers. Additionally, the ArchZeroDataVector may be used to update the speculative and non-speculative freelist bit vectors in the data structure 725, e.g., by combining the ArchZeroDataVector with the speculative or non-speculative free list bit-vectors using an OR operation to mark any zero-data registers as free.

Some embodiments, which may be practiced in addition to or in place of other embodiments described herein, use the ZBit optimization to reclaim architectural registers when not in use. For example, the Zbit array in the data structure 730 is used to reclaim microcode temporary registers or registers that have been cached using techniques such as x87 register caching.

In microcode cases, the FPU 700 may implement eight temporary renamed registers (ftmp0-ftmp7) for use by complex instructions to store intermediate results. When microcode is not being executed, these registers are not defined to hold usable data, so holding entries for the ftmps in the physical register file is inefficient. In some embodiments, the unused ftmp registers are marked as unusable or “dead” when a microcode sequence is not executing and their physical registers are reclaimed by setting the ZBits in the renamer 715. The data values of the ftmps may not be all-zeros but the data value in the dead registers is inconsequential and so these registers may be added to the free list 710 without disrupting or interfering with normal operation of the floating-point unit 700. The free list 710 tracks the physical registers that are mapped to microcode ftmp registers using another 72-entry bit-vector in the data structure 725. This vector may be referred to as the ArchUcodeTmpVector. The ArchUcodeTmpVector may be used to update the speculative and non-speculative freelist bit vectors in the data structure 725, e.g., by combining the ArchUcodeTmpVector with the speculative or non-speculative free list bit-vectors using an OR operation to mark any zero-data registers as free.

Cached registers may be reclaimed by setting Zbits in the renamer 715 in some embodiments. The evolution of instruction set architectures implies that some earlier ISAs may be less commonly used. For example, some floating-point units may be optimized for SSE and AVX single-precision performance and x87 performance may be explicitly de-emphasized. Thus, the design of the floating-point unit 700 may assume that the eight registers that are reserved for x87 instructions may often be unused. In some embodiments, the FPU 700 loads values from a memory image into all of the FPU registers—including the x87 registers—during state-restore instructions such as FXRSTOR or XRSTOR or CC6 restore. Rather than restoring the x87 values to physical registers in the physical register file during the instruction sequence, microcode instead copies the x87 values from the memory image into internal scratch storage in the main processor data cache unit. In some embodiments, the floating-point unit 700 also sets the ZBits in the renamer 715 to indicate that the x87 architectural registers have not been allocated a physical register. The sequence then sets a status bit in an internal control register indicating that the x87 registers are unmapped, or “cached”. If an x87 instruction is detected while the x87 registers are cached, the main core takes a fault and vectors to a sequence which restores the x87 values from the scratch storage space back into the physical register file.

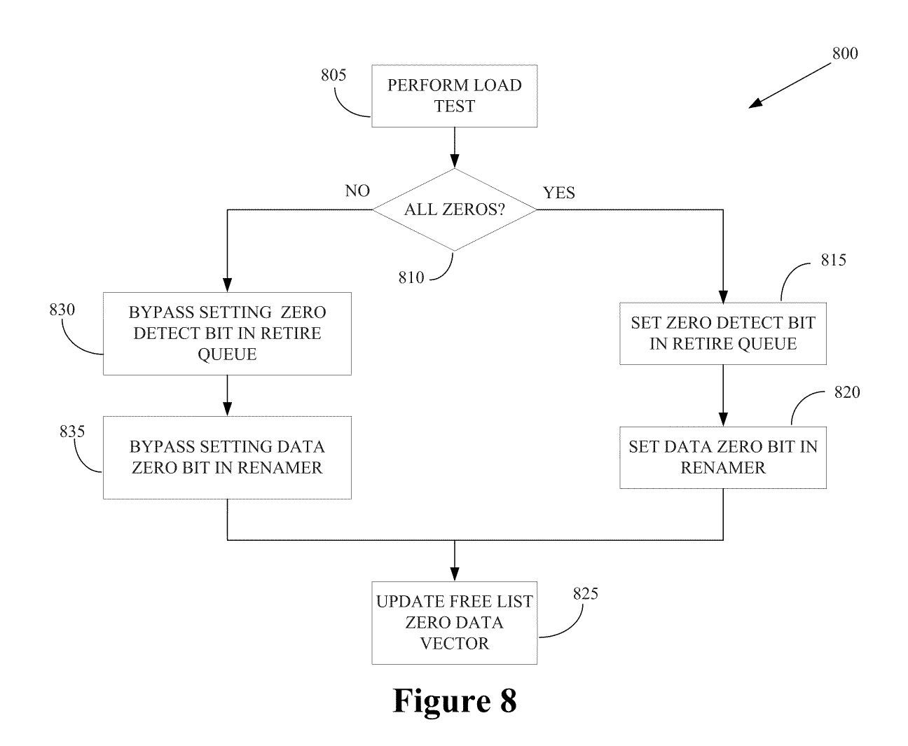

FIG. 8 conceptually illustrates a method 800 for dynamically detecting all-zero registers, according to some embodiments. In some embodiments, the floating-point unit 700 performs (at 805) a load test (such as FPKLDTEST) that reads the bits in one or more architectural registers and determines whether the values in the registers are all zeros or alternatively some other configurable bit pattern. If an all-zero register is detected (at 810), the floating-point unit 700 sets (at 815) a zero detect bit (e.g., a zero-detect status bit in the data structure 720 shown in FIG. 7) in the retire queue 705 to indicate that the corresponding architectural register contains all zeros. The floating-point unit 700 also sets (at 820) a data zero bit (e.g., an entry in the Data0 array in the data structure 730 shown in FIG. 7) in the renamer 715 to indicate that the architectural register associated with an instruction in the retire queue 705 contains all zeros. The floating-point unit 700 then updates the free list 710 to indicate that the architectural register associated with a physical register contains all zeros. If the floating-point unit 700 determines (at 805) that a corresponding register does not contain all zeros (or some other configurable bit pattern), the floating-point unit 700 bypasses (at 830) setting the zero detect bit in the retire queue and bypasses (at 835) setting the data zero bit in the renamer. If necessary, the floating-point unit 700 updates (at 825) the free list 710 to indicate that the architectural register associated with the physical register does not contain all zeros.

Some embodiments may implement combinations of the dispatch-time detection (e.g., as shown in FIG. 5) and retire-time detection (e.g., as shown in FIG. 8) of registers including configurable bit pattern such as all zeros. For example, the FPUs 198, 199 in the system 100 shown in FIG. 1 may use Zbit arrays for reclaiming zero registers for AVX-128 instructions, reclaiming unused or unusable temporary microcode registers such as the ftmp0-ftmp7 registers, supporting x87 register caching, or dynamically detecting registers that include a configurable bit pattern such as all zeros. A unified scheme and a single set of hardware may be used to implement different combinations of these techniques. For example, reclaiming the temporary microcode registers using Zbits instead of a specific PRN encoding may improve the performance of this technique because reclaiming the temporary microcode registers may batch-free several registers all at once. Batch-freeing the temporary registers is most easily accomplished using a bit-vector freelist and an array of single bits per register, as discussed herein. Using a unified scheme to implement embodiments of the techniques for reclaiming registers reduces complexity and hardware cost.

Embodiments of processor systems that can track or reclaim physical registers as described herein (such as the processor system 100) can be fabricated in semiconductor fabrication facilities according to various processor designs. In some embodiments, a processor design can be represented as code stored on a computer readable media. Exemplary codes that may be used to define and/or represent the processor design may include HDL, Verilog, and the like. The code may be written by engineers, synthesized by other processing devices, and used to generate an intermediate representation of the processor design, e.g., netlists, GDSII data and the like. The intermediate representation can be stored on computer readable media and used to configure and control a manufacturing/fabrication process that is performed in a semiconductor fabrication facility. The semiconductor fabrication facility may include processing tools for performing deposition, photolithography, etching, polishing/planarising, metrology, and other processes that are used to form transistors and other circuitry on semiconductor substrates. The processing tools can be configured and are operated using the intermediate representation, e.g., through the use of mask works generated from GDSII data.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

Furthermore, some embodiments of the methods illustrated in FIGS. 5 and 8 may be governed by instructions that are stored in a non-transitory computer readable storage medium and that are executed by at least one processor. Each of the operations shown in FIGS. 5 and 8 may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

what is claimed:

1. A method, comprising:
bypassing allocation of a physical register to an architectural register when information associated with the architectural register satisfies a bypass condition; and
modifying information mapping the physical register to the architectural register to indicate that allocation of a physical register to the architectural register has been bypassed.

2. The method of claim 1, wherein the information satisfies the bypass condition when the information includes a bit pattern that is all zeros.

3. The method of claim 1, wherein the information satisfies the bypass condition when the information includes a configurable non-zero bit pattern or unusable data.

4. The method of claim 1, wherein the information associated with the architectural register comprises information to be written to the architectural register, and comprising determining whether the information to be written to the architectural register satisfies the bypass condition by:
decoding an instruction that writes to the architectural register; and
determining that the architectural register written by the decoded instruction defines a portion of the written data as all zeros.

5. The method of claim 4, comprising fetching the instruction from memory.

6. The method of claim 4, wherein the physical register is a 128-bit register, wherein the architectural register is a 256-bit architectural register, and wherein the decoded instruction defines 128 bits of the destination 256-bit architectural register as all zeros.

7. The method of claim 4, wherein determining whether the information to be written to the architectural register satisfies the bypass condition by:
decoding an instruction that writes to the architectural register; and
determining that the decoded instruction zeros out a portion of the architectural register.

8. The method of claim 7, wherein bypassing allocation of the physical register comprises freeing a physical register that was previously storing the portion of the architectural register that will be zeroed out in response to retirement of the decoded instruction.

9. The method of claim 1, wherein modifying the mapping information comprises at least one of setting a first bit associated with the architectural register or mapping the architectural register to a reserved physical register number.

10. The method of claim 9, comprising determining whether the information associated with the architectural register satisfies the bypass condition by detecting a bit pattern in data loaded into the architectural register from the memory and setting a second bit in a retire queue if a portion of the data loaded into the architectural register matches the bit pattern.

11. The method of claim 10, comprising setting a third bit bit associated with the architectural register in response to retirement of an instruction that references the architectural register when the second bit associated with the architectural register is set.

12. The method of claim 11, comprising modifying the first bit by applying an OR operation to the first bit and the third bit associated with the architectural register in response to an abort command.

13. The method of claim 12, comprising setting a fourth bit to indicate that a physical register is mapped to the architectural register associated with the third bit.

14. The method of claim 13, comprising modifying the fourth bit by applying an OR operation to the fourth bit and a fifth bit that indicates whether the physical register is free to be allocated, wherein the fourth bit is modified in response to the abort command.

15. The method of claim 1, wherein the information associated with the architectural register comprises information stored in the architectural register, and comprising determining whether the information stored in the architectural satisfies the bypass condition by determining whether microcode associated with the architectural register is being executed, wherein the information stored in the architectural register does not comprise usable information when the microcode is not being executed.

16. The method of claim 1, wherein the information associated with the architectural register comprises information stored in the architectural register, and comprising determining whether the information stored in the architectural register satisfies the bypass condition by determining whether information stored in the architectural register has been copied from a memory image into a memory location other than the physical register.

17. The method of claim 1, comprising determining that the architectural register is a source operand of an operation, bypassing reading the physical register when a first bit corresponding to the architectural register is set, and providing a bit pattern as the source operand for the operation when the first bit is set.

18. An apparatus, comprising:
rename logic configurable to map architectural registers to physical registers, wherein the rename logic is configurable to bypass allocation of a physical register to an architectural register in response to determining that information associated with the architectural register satisfies a bypass condition; and
mapping information associated with the architectural registers, wherein the rename logic is configurable to modify the mapping information to indicate that allocation of a physical register to the corresponding architectural register has been bypassed.

19. The apparatus of claim 18, wherein the information associated with the architectural register is all zeros.

20. The apparatus of claim 18, wherein the information associated with the architectural register comprises a non-zero configurable bit pattern or unusable data.

21. The apparatus of claim 18, comprising a decoder configurable to decode instructions and determine whether the information associated with the architectural register satisfies the bypass condition based on the decoded instruction.

22. The apparatus of claim 18, comprising a memory configurable to store instructions.

23. The apparatus of claim 21, wherein the decoder is configurable to determine that the architectural register written by the decoded instruction defines a portion of the written data as all zeros.

24. The apparatus of claim 23, wherein the physical register is a 128-bit register, wherein the architectural register is a 256-bit architectural register, and wherein the decoded instruction defines 128 bits of the destination 256-bit architectural register as all zeros.

25. The apparatus of claim 21, wherein the apparatus is configurable to determine that the decoded instruction zeros out a portion of the architectural register.

26. The apparatus of claim 25, comprising a free list that indicates which physical registers are available for allocation, and wherein bypassing allocation of the physical register comprises modifying the free list to free a physical register that was previously backing the portion of the architectural register that will be zeroed out in response to retirement of the decoded instruction.

27. The apparatus of claim 18, wherein the rename logic is configurable to modify the mapping information by setting a first bit associated with the architectural register or mapping the architectural register to a reserved physical register number.

28. The apparatus of claim 27, comprising a retire queue, and wherein the apparatus is configurable to determine whether the information associated with the architectural register satisfies the bypass condition by detecting the configurable bit pattern in data loaded into the architectural register from the memory and wherein the apparatus is configurable to set a second bit in the retire queue if a portion of the data loaded into the architectural register satisfies the bypass condition.

29. The apparatus of claim 28, comprising a plurality of third bits associated with the rename logic, and wherein the apparatus is configurable to set a third bit associated with the architectural register in response to retirement of an instruction that references the architectural register when the second bit associated with the architectural register is set.

30. The apparatus of claim 29, wherein the apparatus is configurable to modify the first bit by applying an OR operation to the first bit and the third bit associated with the architectural register in response to an abort command.

31. The apparatus of claim 30, wherein the apparatus is configurable to set a fourth bit to indicate that a physical register is mapped to the architectural register associated with the third bit.

32. The apparatus of claim 31, wherein the apparatus is configurable to modify the fourth bit by applying an OR operation to the fourth bit and a fifth bit that indicates whether the physical register is free to be allocated, wherein the fourth bit is modified in response to the abort command.

33. The apparatus of claim 18, wherein the information associated with the architectural register comprises information stored in the architectural register, and wherein the apparatus is configurable to determine whether the information stored in the architectural register comprises usable information by determining whether microcode associated with the architectural register is being executed, and wherein the information stored in the architectural register does not comprise usable information when the microcode is not being executed.

34. The apparatus of claim 18, wherein the information associated with the architectural register comprises information stored in the architectural register, and wherein the apparatus is configurable to determine whether the information stored in the architectural register comprises usable information by determining whether information stored in the architectural register has been copied from a memory image into a memory location other than the physical register.

35. The apparatus of claim 18, wherein the apparatus is configurable to determine that the architectural register is a source operand of an operation, bypass reading the physical register when the first bit corresponding to the architectural register is set, and provide the configurable bit pattern as the source operand for the operation when the first bit is set.

36. A computer readable media including instructions that when executed can configure a manufacturing process used to manufacture a semiconductor device comprising:
rename logic configurable to map architectural registers to physical registers, wherein the rename logic is configurable to bypass allocation of a physical register to an architectural register in response to determining that information associated with the architectural register satisfies a bypass condition; and
a plurality of first bits associated with the architectural registers, wherein the rename logic is configurable to set one of the first bits to indicate that allocation of a physical register to the corresponding architectural register has been bypassed.

37. The computer readable media set forth in claim 36, further comprising instructions that when executed can configure the manufacturing process used to manufacture the semiconductor device comprising a physical register file comprising a plurality of 128-bit physical registers.
